(19) United States
(12) Patent Application Publication
(10) Pub. No.: US 2008/0083790 A1
(43) Pub. Date: Apr. 10, 2008

(54) Extruding mechanism

(76) Inventor: Yu-Chun Tseng, Tainan City (TW)

Correspondence Address: BACON & THOMAS, PLLC, 625 SLATERS LANE, FOURTH FLOOR, ALEXANDRIA, VA, 22314, US

(21) Appl. No.: 11/543,919

(22) Filed: Oct. 6, 2006

(51) Int. Cl. B67D 5/42

(52) U.S. Cl. 222/391

(57) ABSTRACT

An extruding mechanism includes a retaining base, a first handle provided for handling, a push rod pivotally coupled and having both ends extended out from a retaining base, a first resilient member and a first latch plate pivotally connected to a push rod in the retaining base; a poking member disposed on the retaining base; a second handle installed on the retaining base and having a driving arm at an end of the second handle, such that when the driving arm is turned clockwise or counterclockwise, the push rod can be shifted directly or indirectly by the first latch plate in the retaining base after being pressed by the poking member.

### BACKGROUND OF THE INVENTION

1. Field of the Invention

The present invention relates to an extruding mechanism, and more particularly to a mechanism with a simple structure capable of directly or indirectly pushing a push rod by operating and shifting a handle towards different directions.

2. Description of the Related Art

In general, silicone is commonly used in watertight seals for constructions, decorations or DIY home remodeling, and a silicone sealant can be extruded out from a circular slender can by a silicon gun, and the handle for applying a force to a handle of the silicon gun is installed perpendicular to the can of silicon sealant and thus the silicon gun occupies a relatively large packaging volume. Furthermore, a user usually holds a base stand by one hand and grabs the handle by another hand for the operation. Therefore, the inventor of the present invention has filed U.S. application Ser. No. 10/60674 entitled “Extruding implement structure” that provides a design of installing a handle pivotally coupled onto a rear retaining base and disposed on a side of the base stand, and the handle is installed axially or slightly oblique with a base stand and a push rod. If it is necessary to penetrate and push a rear cover in a can of silicon sealant by a contact dish at the front end of the push rod to shoot the silicon, a user can hold the handle at a position close to the base stand. Such design can greatly reduce the packaging volume, and users can operate the extruding mechanism by one hand in a convenient manner.

However, the traditional silicon gun with its handle for applying a force installed perpendicular to the can of silicon sealant or the extruding implement structure disclosed in U.S. application Ser. No. 10/60674 have their own advantages. The former is operated by both hands to extend the base stand of the can of silicon sealant forward, and thus it can be used for the construction at a farther position. The latter is operated by a single hand to hold the handle and the base stand that contains the can of silicone sealant, and thus it can be used for the detailed construction at a near distance and achieves the effects of saving efforts and providing good stability and high quality.

Since the foregoing two arrangements have their advantages, we can make constructions more convenient and easy if an extruder with a simple structure and the advantages of the foregoing two arrangements.

### SUMMARY OF THE INVENTION

The objective of this invention is to provide an improved extruding mechanism, which includes:

a retaining base, having a first handle provided for handling and a push rod pivotally coupled thereon; and both ends of the push rod are extended out from the retaining base, and a first resilient member and a first latch plate pivotally coupled to the push rod in the retaining base; and a poking member disposed on the retaining base;

a second handle, installed on the retaining base, and having a driving arm disposed at an end of the second handle, such that when the driving arm rotates counterclockwise, the first latch plate in the retaining base is poked; when the driving arm rotates clockwise, the first latch plate is poked indirectly by the poking member after the poking member in the retaining base is poked;

thereby, the second handle is shifted in different directions for directly or indirectly poking the first latch plate to shift the push rod.

### BRIEF DESCRIPTION OF THE DRAWINGS

Other features and advantages of the present invention will become apparent in the following detailed description of the preferred embodiments with reference to the accompanying drawings, in which:

FIG. 1 is a schematic view of the structure of a preferred embodiment of the present invention;

FIG. 2 is a schematic perspective view of installed first handle, second handle and poking member according to a preferred embodiment of the present invention;

FIG. 3 is schematic view of a mechanism operated by turning a second handle counterclockwise according to a preferred embodiment of the present invention; and

FIG. 4 is a schematic view a mechanism operated by turning a second handle clockwise according to a preferred embodiment of the present invention.

### DETAILED DESCRIPTION OF THE PREFERRED EMBODIMENTS

In the detailed description of the preferred embodiments, it should be noted that like elements are indicated by the same reference numerals throughout the disclosure.

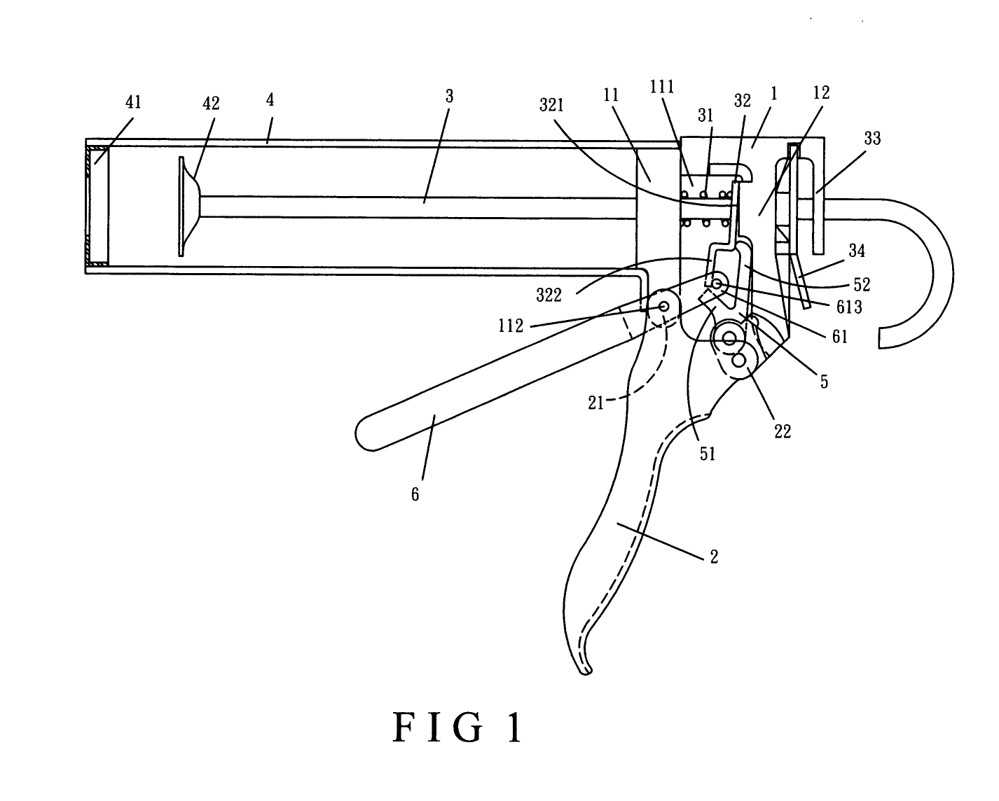

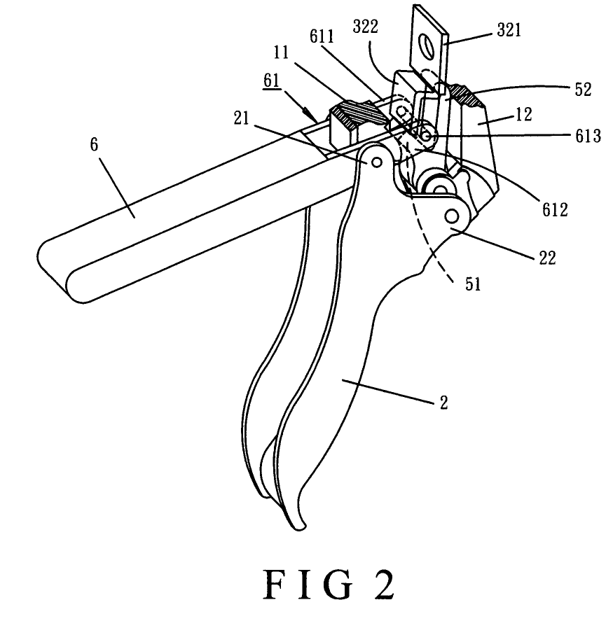

Referring to FIGS. 1 and 2, an extruding mechanism in accordance with a preferred embodiment of the present invention comprises:

a retaining base 1, having a first handle 2 provided for handling and a push rod 3 pivotally coupled thereon; the retaining base 1 separates a front retaining stand 11, a rear retaining stand 12 and support stand 13 to form a first hollow interval 111 and a second hollow interval 121; both ends of the push rod 3 are extended out from the front retaining stand 11 and rear retaining stand 12 of the retaining base 1, and a first resilient member 31 and a first latch plate 32 of the push rod 3 are pivotally coupled to the first hollow interval 111 of the retaining base 1; the first latch plate 32 forms a first latch portion 321 and a second latch portion 322 in a curved shape and pivotally coupled to the retaining base 1; and the first handle 2 is pivotally coupled to the front retaining stand 11 and rear retaining stand 12 by crotched pivotal handles 21, 22 respectively;

a base stand 4 disposed at an end of the retaining base 1, and having a front blocking base 41, and an end of the push rod 3 extended out from the retaining base 1 is extended into the base stand 4 and having a contact dish 42 at a front end of the push rod 3, a pulling base 33 disposed at an end out of the retaining base 1; a second latch plate 34 of the push rod 3 is embedded into a second hollow interval 121 in the retaining base 1; and an end of the second latch plate 34 is blocked by a latch base 122 of the retaining base 1;

a poking member 5, disposed on the retaining base 1, and pivotally coupled onto a rear retaining stand 12 of the retaining base 1, and having a first poking handle 51 and a second poking handle 52 crotched with an appropriate angle; wherein the first poking handle 51 is crotched with an appropriate distance from the second poking handle 52 and a pivotal point of the rear retaining stand 12;

a second handle 6, pivotally coupled to a front retaining stand 11 of the retaining base 1, and comprised of a driving arm 61 disposed at an end of the second handle, and the driving arm 61 comprised of two crotched side arms 611, 612 and a poking pin 613 disposed between the two crotched side arms 611, 612; such that when the driving arm 61 rotates counterclockwise, the poking pin 613 is used for pushing the second latch portion 322 of the first latch plate 32 in the retaining base 1; when the driving arm 61 rotates clockwise, the poking pin 613 is used for pushing a first poking handle 51 of the poking member 5 in the retaining base 1, and indirectly pushing the second latch portion 322 of the first latch plate 32 by the second poking handle 52 of the poking member 5; and both of the second handle 6 and the pivotal handle 21 of the first handle 2 are pivotally coupled onto a pivotal point 112 of the front retaining stand 11;

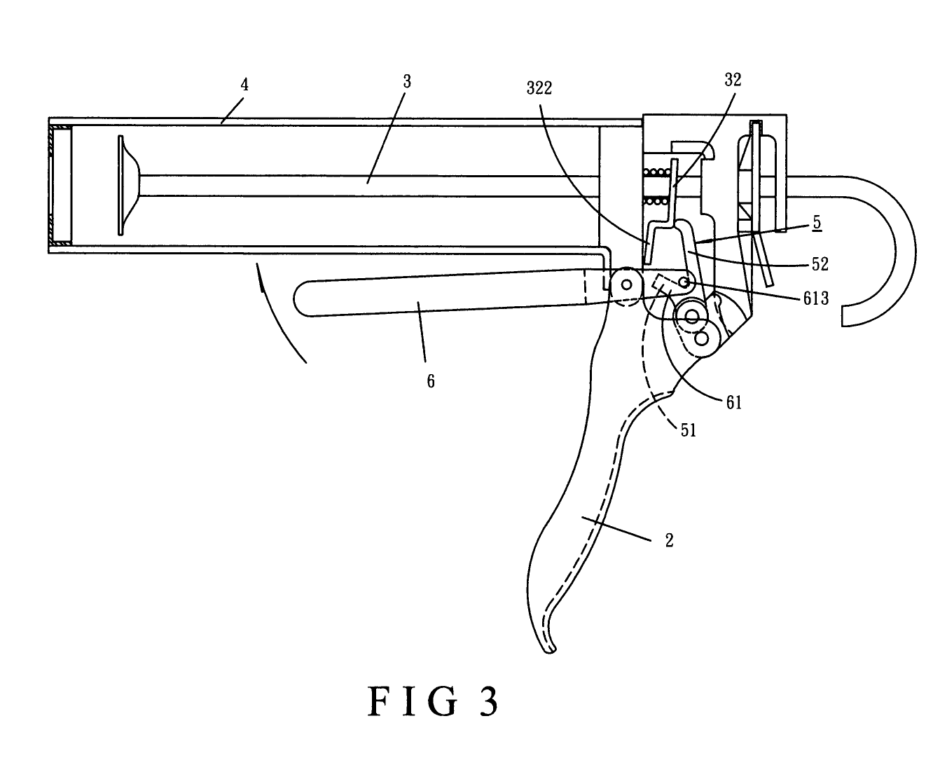

If the driving arm 61 of the second handle 6 rotates clockwise, the second handle 6 is pressed and moved from a stop position as shown in FIG. 1 in a direction away from the first handle 2 towards the base stand 4 as shown in FIG. 3. Then, a short-distance construction can be performed appropriately. The driving arm 61 at another end of the second handle 6 pushes a first poking handle 51 of the poking member 5 by a poking pin 613 to indirectly push the second latch portion 322 of the first latch plate 32 by the second poking handle 52 of the poking member 5, such that the first latch plate 32 is titled to link the push rod 3 to move forward.

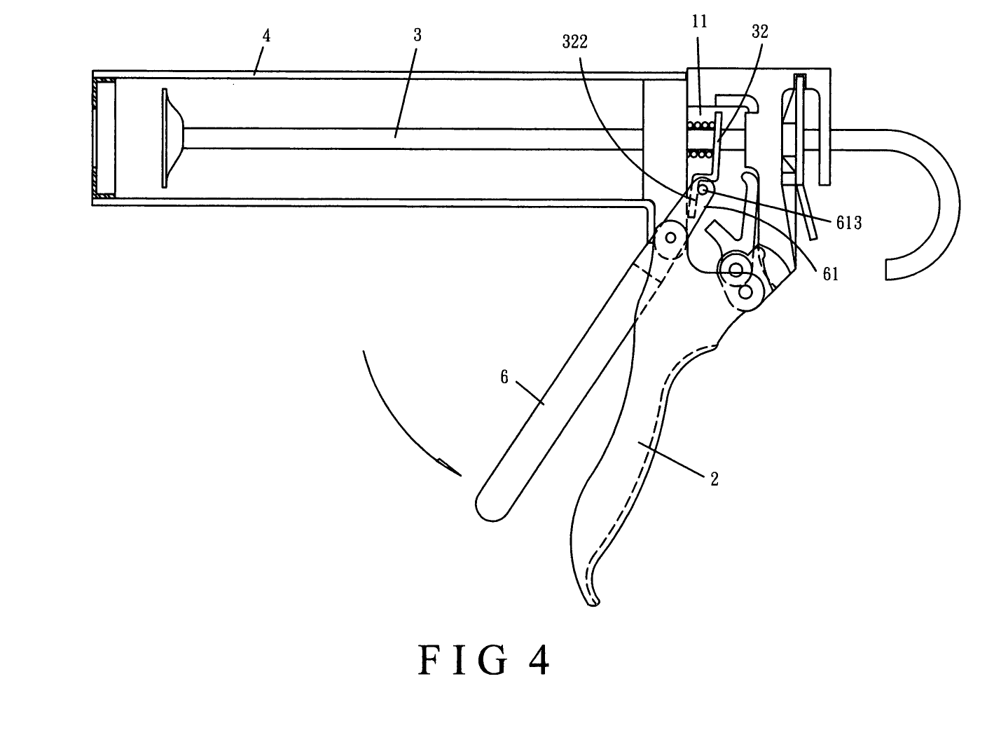

If the driving arm 61 of the second handle 6 rotates counterclockwise, the second handle 6 is pressed and moved from a stop position as shown in FIG. 1 towards the first handle 2 as shown in FIG. 4. Then, a far-distance construction can be performed appropriately. The driving arm 61 at another end of the second handle 6 pushes the second latch portion 322 of the first latch plate 32 in the first hollow interval 11 directly by the poking pin 613, such that the first latch plate 32 is titled to link the push rod 3 to move forward.

In summation of the description above, the design of a preferred embodiment of the present invention provides an extruding mechanism with a simple structure, such that users can use one hand to hold the second handle for a clockwise or a counterclockwise operation in different construction occasions, so as to directly or indirectly poke the first latch plate to shift the push rod. Unlike the traditional extruder, the structure of the invention does not increase the packaging volume. Compared with the U.S. application Ser. No. 10/60674 entitled “Extruding implement structure” and filed by the inventor of the present invention, the present invention provides a convenient way of conducting a far-distance construction. The preferred embodiment of the present invention is not limited for the application for a silicone extruder, but also is applied for any tool that requires pushing a push rod similar to the hot-melting silicone gun.

While the invention has been described by means of specific embodiments, numerous modifications and variations could be made thereto by those skilled in the art without departing from the scope and spirit of the invention set forth in the claims.

What is claimed is:

1. An extruding mechanism, comprising:
a retaining base, having a first handle provided to be held, and a push rod pivotally coupled thereon; and both ends of said push rod being extended out from said retaining base, and a first resilient member and a first latch plate push rod being pivotally coupled in said retaining base; and being disposed on a poking member said retaining base; and
a second handle, installed on said retaining base, and having a driving arm disposed at an end of said second handle, such that when said driving arm rotates counterclockwise, said first latch plate in said retaining base is poked; when said driving arm rotates clockwise, said first latch plate is poked indirectly by said poking member after said poking member in said retaining base is poked;
thereby, said second handle is shifted in different directions for directly or indirectly poking said first latch plate to shift said push rod.

2. The extruding mechanism as claimed in claim 1, wherein said poking member includes a first poking handle and a second poking handle; and said driving arm of said second handle pushes said first poking handle of said poking member, and said second poking handle pushes said first latch plate in said retaining base.

3. The extruding mechanism as claimed in claim 1, wherein said first latch plate includes a first latch portion formed in a curved shape and pivotally coupled to said retaining base, and a second latch portion pushed by a driving arm at an end of said second handle.

4. The extruding mechanism as claimed in claim 1, wherein said retaining base includes a base stand disposed at an end of said retaining base, and having a front blocking base, and an end of said push rod extended out from said retaining base is extended into said base stand.

5. The extruding mechanism as claimed in claim 1 or claim 4, wherein said push rod has an end extended out from said retaining base and embedded into a second latch plate, and an end of said second latch plate is embedded onto said retaining base.

6. The extruding mechanism as claimed in claim 1, wherein said second handle is shifted from a stop position towards said first handle, when said driving arm of said second handle rotates counterclockwise; and said second handle is shifted from a stop position in a direction away from said first handle, when said driving arm of said second handle rotates clockwise.

7. The extruding mechanism as claimed in claim 4, wherein said second handle is shifted from a stop position towards said first handle, when said second handle driving arm rotates counterclockwise; and said second handle is shifted from a stop position towards said base stand, when said second handle driving arm rotates clockwise.

8. The extruding mechanism as claimed in claim 1, wherein said first handle with a crotched pivotal handle pivotally coupled to a front retaining stand and a rear retaining stand disposed on said retaining base.

9. The extruding mechanism as claimed in claim 2, wherein said first poking handle is crotched from said second poking handle with an appropriate interval from a pivotal point of said rear retaining stand.

10. The extruding mechanism as claimed in claim 1, wherein said driving arm is comprised of two crotched side arms and having a poking pin disposed between said two side arms.
